(19) United States
(12) Patent Application Publication
(10) Pub. No.: US 2014/0374268 A1
(43) Pub. Date: Dec. 25, 2014

(54) METHOD FOR FORMING A COMPOSITE FILM

(71) Applicant: Agency for Science, Technology and Research, SINGAPORE (SG)

(72) Inventors: Yongling WU, Singapore (SG); Wei HE, Singapore (SG)

(73) Assignee: Agency for Science, Technology and Research, SINGAPORE (SG)

(21) Appl. No.: 14/313,313

(22) Filed: Jun. 24, 2014

(30) Foreign Application Priority Data
Jun. 24, 2013 (SG) SG201304901-0

(51) Int. Cl. B05D 3/14; B05D 3/00; B05D 3/10; C25D 5/02; C08J 5/18; C25D 5/48; C25D 3/46; C25D 3/48; B05D 1/00; C08J 5/00

(52) U.S. Cl. CPC B05D 3/14; B05D 1/005; B05D 3/002; B05D 3/102; C08J 5/005; C08J 5/18; C25D 5/48; C25D 3/46; C25D 3/48; C25D 5/02; C08J 2333/12
USPC 205/118; 216/83

(57) ABSTRACT

According to embodiments of the present invention, a method for forming a composite film is provided. The method includes providing a nanowire forming template, forming a plurality of nanowires through the nanowire forming template, removing material from a partial portion of the nanowire forming template to expose a portion of the plurality of nanowires, and forming a polymeric film between the plurality of nanowires to form a composite film.

### CROSS-REFERENCE TO RELATED APPLICATION

This application claims the benefit of priority of Singapore patent application No. 201304901-0, filed Jun. 24, 2013, the contents of which are incorporated herein by reference for all purposes.

### TECHNICAL FIELD

Various embodiments relate to a method for forming a composite film

### BACKGROUND

Making metal-polymer nanocomposite films involves two steps: synthesis of nanowires and integration with polymer. Current metal nanowire-polymer nanocomposite film is mostly made by dispersing already synthesized metal nanowires into a solution containing a polymer or a precursor of the polymer. The nanowires are randomly distributed and without order. It is even harder to place the nanowires perpendicular to the nanocomposite surface.

For the first step, which is synthesis of the nanowires, one of the approaches is to grow the nanowires with the desired direction and spacing and fill in the gaps between them with the polymer. The other approach is to use an external force (electrical or magnetic) to align the floating nanowires within the polymer solution. For the first method, templates are often used to guide the growth of the nanowires. Patterned photoresist and materials with cylindrical holes and voids are used to grow nanowires. For materials with cylindrical holes, an anodized aluminum oxide (AAO) and ion track-etched polymers are often used to grow nanowires. Other methods also include placing seed nanoparticles through template methods and then growing nanowires from the seed towards a desired direction.

For the second step, which is integration with a polymer, some approaches involve introducing the polymer solution or solution of the monomer of the polymer between the gaps of the nanowires after completely removing the templates. A curing session is needed to solidify the polymer. For nanocomposite films produced in an electrical (or magnetic) field, the polymer solution is mixed with the nanowires before the electrical (or magnetic) field is applied. The curing session is done while the electrical (or magnetic) field is on to help maintain the orderness of the metal nanowires.

For the approach of using an external force to align the floating nanowires within the polymer solution, the orientation of the nanowires would be aligned in one direction, but the spacing between the nanowires would be hard to control. When a patterned photoresist is used as the template to synthesis the ordered nanowires, it is hard to make long nanowires because of develop issues with a thick photoresist. The requirements for substrates are very high in order to avoid the overexposure or underexposure phenomenon. It is also a very slow process to produce nanocomposites. When an ion track-etched polymer is used to grow nanowires, the nanowires are not straight and have low density. For methods using AAO and ion track-etched polymers as the templates, thermal evaporation on the backside is needed to seal the backend of the template which could introduce contamination and increase the cost of the procedure. For long nanowires over 10 μm with a diameter less than 300 nm, there are no successful techniques to avoid collapse between the nanowires.

Further, because of the nature of the nanocomposite, it is very hard to process the nanocomposite film once it is made. For applications in the form of a thin film, the surface flatness is of great interest. For all the approaches up to date to obtain metal nanowire-polymer composite films, the flatness of the surface is not controllable.

### SUMMARY

According to an embodiment, a method for forming a composite film is provided. The method may include providing a nanowire forming template, forming a plurality of nanowires through the nanowire forming template, removing material from a partial portion of the nanowire forming template to expose a portion of the plurality of nanowires, and forming a polymeric film between the plurality of nanowires to form a composite film.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a flow chart illustrating a method for forming a composite film, according to various embodiments.

FIG. 2 shows an exploded view of an electrodeposition cell, according to various embodiments.

FIGS. 3A to 3G show, as perspective views, various processing stages of a method for synthesizing a metal-polymer nanocomposite film using a commercial anodized aluminum oxide (AAO) template, according to various embodiments.

FIGS. 4A to 4F show, as perspective views, various processing stages of a method for synthesizing a metal-polymer nanocomposite film using a self-grown anodized aluminum oxide (AAO) template, according to various embodiments.

FIGS. 5A and 5B show images of free standing silver (Ag)-PMMA and silver (Ag)-PDMS nanocomposite films respectively, according to various embodiments.

FIG. 5C shows an image of a nanocomposite film with gold nanowires in a polymer matrix, according to various embodiments.

FIG. 6A shows a scanning electron microscope (SEM) image of a top view of an anodized aluminum oxide (AAO) template while FIG. 6B shows a scanning electron microscope (SEM) image of a top view of exposed ends of silver (Ag) nanowires, according to various embodiments.

FIGS. 7A and 7B show scanning electron microscope (SEM) images of a cross sectional view of a silver (Ag)-polymer nanocomposite film, according to various embodiments.

FIG. 8 shows an EDX (Energy-dispersive X-ray spectroscopy) spectrum of a silver (Ag)-PMMA nanocomposite film, according to various embodiments.

FIG. 9 shows a schematic cross sectional view of a nanowire meta-lens structure with a top object, according to various embodiments.

FIG. 10 shows a plot of Poynting vector (S) for a gaussian wave incident on a meta-lens, according to various embodiments.

FIGS. 11A to 11C show plots of the distribution of electric field intensities in a meta-lens of various embodiments at wavelengths, λ, of about 391.3 nm, about 435.5 nm and about 491 nm respectively.

FIG. 12 shows a plot of the electric field intensity distribution in a meta-lens of various embodiments at a wavelength of about 466 nm.

FIG. 13A shows an example of an object to be imaged while FIGS. 13B and 13C show polarized images by a meta-lens of various embodiments at a wavelength of about 1200 nm.

FIG. 14A shows a plot of the optical simulation of far field imaging of a nanometer object by a curved hyperlens, according to various embodiments.

FIG. 14B shows a plot of the electric field intensity at different distances away from the hyperlens of FIG. 14A.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the phrase “at least substantially” may include “exactly” and a reasonable variance.

In the context of various embodiments, the term “about” as applied to a numeric value encompasses the exact value and a reasonable variance.

As used herein, the term “and/or” includes any and all combinations of one or more of the associated listed items.

Various embodiments may relate to metal-polymer nanocomposite film materials, for example nanocomposite materials composed of highly-ordered vertically-aligned metal nanowires embedded within a polymer film. Various embodiments may relate to the structures of the nanocomposite films and methods to fabricate such structures.

Various embodiments may provide a fabrication process for a free-standing metal-polymer nanocomposite film with ordered vertically-aligned metal nanowires, for example, for optical applications.

Various embodiments may provide a process to fabricate a nanocomposite film by first fixing a nanowire forming template (e.g. an anodized aluminum oxide (AAO) template) onto a hard substrate with a conducting or conductive sacrificial layer sitting in between. Then, electrodeposition may be used to grow a metal nanowire array within the template. The AAO template may then be partially etched, for example halfway etched, to expose the top ends of the array of metal nanowires, leaving a portion of the AAO to support the metal nanowire array. A miscible solvent may be used to replace the residual electroplating solution between the gaps of nanowires of the nanowire array before a polymer solution, which may contain the same solvent, may be spin-coated on top to seal the exposed ends of the nanowire array. An etching solution may then be used to remove the conductive sacrificial layer to release the polymer film and expose the bottom ends of the metal nanowires of the nanowire array. Optionally, another etching solution may then be used to remove the interconnected metal nanowires at the bottom side before spin-coating a polymer layer on the bottom side to form a complete free-standing composite film.

Various embodiments may provide an easy way to fix a nanowire forming template (e.g. an AAO template) onto a substrate to form an electrodeposition cell. Compared to other approaches to integrate a working electrode onto the template, various embodiments may provide an approach to omit or remove the usage of a conducting glue and/or backside metal evaporation to seal the holes of the template, where the glue and backside metal evaporation are contamination sources. The glue and backside metal of the prior art may not be suitable for the wet electro-chemical process of the methods of various embodiments, as the glue and backside metal are not stable in the electro-chemical depositing process. Accordingly, in contrast, in the methods of various embodiments, a conductive sacrificial layer may be employed, where the conductive sacrificial layer may be at least substantially stable in a specified or predetermined electrolyte or electroplating solution that is to be used. Further, the required conductivity and chemical resistance are relatively high in the methods of various embodiments. In other words, the conductive sacrificial layer, apart from having a high conductivity, may have a high chemical resistance against the electroplating solution.

Various embodiments may employ a thin conductive sacrificial layer to help the electrodeposition process and release of the nanocomposite film.

Various embodiments may provide a method to grow long (e.g. >10 μm) and dense (e.g. about 10⁹-10¹¹ pores/cm²) metal nanowire array and embedded into a polymer film to form a nanocomposite, such as a nanocomposite film. Various embodiments may also provide a nanocomposite film formed therefrom. In order to prevent or minimise the surface tension from pulling the nanowires so as to lean towards each other during the solvent evaporation process, a miscible solvent along with a half-way etched template may be used to maintain the separation between the nanowires before the polymer solution is introduced.

Various embodiments may provide a method that employs spin-coating of polymer to produce highly flat surface for thin film nanocomposite applications.

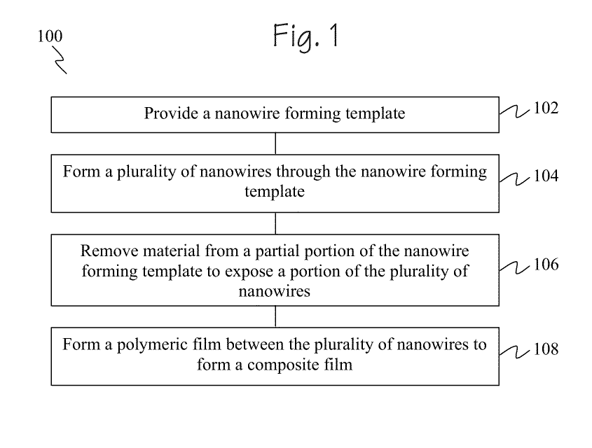

FIG. 1 shows a flow chart 100 illustrating a method for forming a composite film, according to various embodiments.

At 102, a nanowire forming template is provided.

At 104, a plurality of nanowires may be formed through the nanowire forming template.

At 106, material from a partial portion of the nanowire forming template may be removed to expose a portion of the plurality of nanowires. This may mean that there may be a remaining portion of the nanowire forming template, which may help to support the plurality of nanowires.

At 108, a polymeric film may be formed between the plurality of nanowires to form a composite film.

In the context of various embodiments, the nanowire forming template may be or may include an anodized aluminium oxide (AAO) template, or a di-block co-polymer self-assembled template (which for example may be used to deposit metal nanowires (e.g. Ag, Au nanowires)).

In various embodiments, when using a di-block co-polymer self-assembled template, the film thickness of the resulting composite film may be about 500 nm or below (e.g. 500 nm). However, a multi-layer arrangement may be provided for the di-block co-polymer self-assembled template so as to form a thicker composite film. Further, due to the thin film thickness, there may be challenges in separating the composite film from the substrate to form a free-standing film.

In various embodiments, the nanowire forming template may be porous, meaning that the nanowire forming template may have a plurality of pores or holes. The pores or holes may be cylindrical in geometry. The pores may be defined through the nanowire forming template. For example, the pores may extend through the entire thickness of the nanowire forming template. The pores may be at least substantially aligned to each other, for example aligned at least substantially parallel to each other. Further, the nanowire forming template may have a regular distribution of aligned through pores. In various embodiments, the pore size may be variable. For example, the pore size (e.g. a few nm to about 70 nm) may be varied by adjusting the molecular weight/size of the di-block co-polymer, while the pore size of the AAO (e.g. about 20 nm to about 200 nm) may be adjusted by varying the electrolyte and the process parameters used. In various embodiments, at 104, the plurality of nanowires may be formed within or through the pores of the nanowire forming template.

In the context of various embodiments, the polymeric film may include a material or a matrix material having optical transparency for light transmission and/or flexibility to be formed into a curved shape. In other words, the polymeric film may be at least substantially optically transparent for light transmission and/or at least substantially flexible to be formed into an at least substantially curved shape.

In various embodiments, at 108, the polymeric film may be formed at the exposed portion of the plurality of nanowires. This may mean that the polymeric film may embed the exposed portion of the plurality of nanowires or embed the plurality of nanowires. In various embodiments, the polymeric film may cover at least the exposed portion of the plurality of nanowires. The polymeric film may also cover the remaining portion of the nanowire forming template.

In the context of various embodiments, the exposed portion of the plurality of nanowires may correspond to the top or upper portion such that the top ends of the plurality of nanowires may be exposed.

In the context of various embodiments, at 106, removing material from a partial portion of the nanowire forming template may mean that material along a height direction of the nanowire forming template may be removed. Therefore, after removal of the material, the height of the nanowire forming template may be reduced. In other words, a portion of the plurality of nanowires along a longitudinal axis of the plurality of nanowires may be exposed.

In various embodiments, at 108, forming a polymeric film between the plurality of nanowires may consist of forming the polymeric film at the exposed portion of the plurality of nanowires.

In various embodiments, at 106, the nanowire forming template may be etched to remove material from the partial portion of the nanowire forming template.

In various embodiments, at 106, the partial portion of the nanowire forming template may correspond to half of the nanowire forming template, meaning that half of the nanowire forming template may be removed. In other words, the thickness of the nanowire forming template may be reduced in half after the removal process. In various embodiments, the nanowire forming template may be etched half-way, for example along a thickness direction of the nanowire forming template.

In various embodiments, at 104, the plurality of nanowires may be formed through the nanowire forming template by electrodepositing the plurality of nanowires. This may mean that an electrodeposition process may be performed to grow the plurality of nanowires through the nanowire forming template. In the context of various embodiments, the electrodeposition current may be between about 1 mA and about 10 mA, for example between about 1 mA and about 5 mA, between about 1 mA and about 3 mA, between about 3 mA and about 10 mA, between about 5 mA and about 10 mA, or between about 3 mA and about 8 mA, e.g. about 1 mA, about 3 mA, about 5 mA or about 10 mA. The described electrodeposition current may be suitable for example for a sample size of about 25 mm in diameter. It should be appreciated that other electrodeposition current values may be provided, for example depending on the sample size used for the electrodeposition process. In the context of various embodiments, the electrodeposition duration may be between about 10 minutes and about 60 minutes, for example depending on the length of the nanowires to be formed For example, the electrodeposition duration may be between about 10 minutes and about 40 minutes, between about 10 minutes and about 20 minutes, between about 20 minutes and about 60 minutes, between about 20 minutes and about 40 minutes, or between about 30 minutes and about 50 minutes, e.g. about 10 minutes, about 20 minutes, about 40 minutes or about 60 minutes.

In various embodiments, the method may further include providing a conductive layer, wherein the nanowire forming template may be provided on the conductive layer.

In the context of various embodiments, the conductive layer may include a metal. The metal may be selected from the group consisting of silver (Ag), gold (Au), platinum (Pt), nickel (Ni), and lead (Pd).

In the context of various embodiments, the conductive layer may be a metal foil. In the context of various embodiments, the conductive layer may act as a sacrificial layer, e.g. a conductive sacrificial layer.

In the context of various embodiments, the conductive layer may have a conductivity, in terms of sheet resistance of between 0 and about 50 ohms per square, for example between 0 and about 30 ohms per square, between 0 and about 20 ohms per square, between 0 and about 10 ohms per square, between about 20 ohms per square and about 50 ohms per square, or between about 10 ohms per square and about 30 ohms per square.

In various embodiments, the nanowire forming template may be hot pressed or hot embossed on the conductive layer.

In various embodiments, in order to provide the conductive layer, the conductive layer may be formed on a substrate. In this way, the nanowire forming template may be provided on the substrate, with the conductive layer therebetween. In the context of various embodiments, the conductive layer may be formed on the substrate by an evaporation process or a sputtering process.

In various embodiments, in forming the plurality of nanowires through the nanowire forming template, the plurality of nanowires may be formed on the conductive layer.

In various embodiments, the plurality of nanowires may be formed on the conductive layer by electrodepositing the plurality of nanowires by means of the conductive layer. This may mean that an electrodeposition process may be performed to grow the plurality of nanowires on the conductive layer through the nanowire forming template, where the conductive layer may be employed as an electrode for the electrodeposition process, for example as a working electrode. In the context of various embodiments, the electrodeposition current may be between about 1 mA and about 10 mA, for example between about 1 mA and about 5 mA, between about 1 mA and about 3 mA, between about 3 mA and about 10 mA, between about 5 mA and about 10 mA, or between about 3 mA and about 8 mA, e.g. about 1 mA, about 3 mA, about 5 mA or about 10 mA. The described electrodeposition current may be suitable for example for a sample size of about 25 mm in diameter. It should be appreciated that other electrodeposition current values may be provided, for example depending on the sample size used for the electrodeposition process. In the context of various embodiments, the electrodeposition duration may be between about 10 minutes and about 60 minutes, for example depending on the length of the nanowires to be formed For example, the electrodeposition duration may be between about 10 minutes and about 40 minutes, between about 10 minutes and about 20 minutes, between about 20 minutes and about 60 minutes, between about 20 minutes and about 40 minutes, or between about 30 minutes and about 50 minutes, e.g. about 10 minutes, about 20 minutes, about 40 minutes or about 60 minutes.

In various embodiments, the method may further include removing the conductive layer, e.g. after the plurality of nanowires have been formed on the conductive layer. The conductive layer may be removed by etching the conductive layer. This may mean that in various embodiments, the conductive layer may be removed by providing an etching solution to selectively remove the conductive layer. As a result of removing the conductive layer, the bottom ends of the nanowires may be exposed. Further, as a result of the removal of the conductive layer, the polymeric film may be released. In this way, the composite film may be a free-standing composite film.

In various embodiments, the method may further include providing a solvent between the plurality of nanowires prior to forming the polymeric film between the plurality of nanowires. This may help to maintain separation between the nanowires before the polymeric film is formed. In various embodiments, the solvent may be provided to the exposed portion of the plurality of nanowires, meaning that the solvent may be provided after removal of material from the partial portion of the nanowire forming template. In the context of various embodiments, the solvent may be a miscible solvent. The solvent may be the same solvent contained in a polymer solution that may be used for forming the polymeric film.

In various embodiments, at 108, a polymer solution corresponding to the polymeric film may be spin-coated for forming the polymeric film between the plurality of nanowires. Therefore, a spin-coating process may be performed using a polymer solution that may be employed to form the polymeric film.

In various embodiments, the method may further include removing the remaining portion of the nanowire forming template, e.g. after forming the polymeric film between the plurality of nanowires. As a non-limiting example, the remaining portion of the nanowire forming template may be etched to remove the remaining portion of the nanowire forming template. This may mean that another etching solution may be used for the etching process.

In various embodiments, the method may further include forming the polymeric film between the plurality of nanowires that are exposed after the remaining portion of the nanowire forming template is removed.

In the context of various embodiments, each nanowire may include or may be made of a metal. The metal may be selected from the group consisting of silver (Ag), gold (Au), platinum (Pt), nickel (Ni), and lead (Pd).

In the context of various embodiments, the plurality of nanowires may have a length of about 10 μm or more (e.g. ≧10 μm), for example ≧15 μm, ≧20 μm, or ≧30 μm.

In the context of various embodiments, the nanowire forming template may have a pore density of between about 10⁹ pores/cm² and about 10¹¹ pores/cm². This may mean that a high density of nanowires may be formed, for example, in an area of cm², there may be between about 10⁹ and about 10¹¹ nanowires.

In the context of various embodiments, the term “nanowire” or its plural form may include a reference to a “nanorod” or correspondingly its plural form.

In the context of various embodiments, the polymeric film may include a polymer selected from the group consisting of polymethyl methacrylate (PMMA), polydimethylsiloxane (PDMS), polycarbonate (PC), and polyurethane (PU).

In the context of various embodiments, the composite film may include a plurality of nanowires at least substantially vertically aligned.

In the context of various embodiments, the nanowires may be at least substantially vertically aligned relative to a surface of the polymer film embedding the nanowires or a surface of the substrate. This may mean that the nanowires may be arranged at least substantially perpendicular relative to a surface of the polymer film embedding the nanowires or a surface of the substrate.

In the context of various embodiments, the composite film may be a metal-polymer composite film.

In the context of various embodiments, the composite film may be a nanocomposite film.

In the context of various embodiments, the composite film may be at least substantially flexible.

Various embodiments may also provide a method of forming a composite film. The method may include one or more of the steps or processes as described herein.

Various embodiments may also provide a method for or of forming a composite film, the composite film including a plurality of nanowires at least substantially vertically aligned. The method may include one or more of the steps or processes as described herein.

Various embodiments may also provide a method for or of forming a composite film. The method may include providing a conductive layer, providing a nanowire forming template on the conductive layer, forming a plurality of nanowires on the conductive layer through the nanowire forming template, removing material from the nanowire forming template to expose a portion of the plurality of nanowires, and forming a polymeric film between the plurality of nanowires to form a composite film. The method may further include one or more of the steps or processes as described herein.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

Non-limiting examples of the methods of various embodiments will be described using an anodized aluminum oxide (AAO) template as the nanowire forming template.

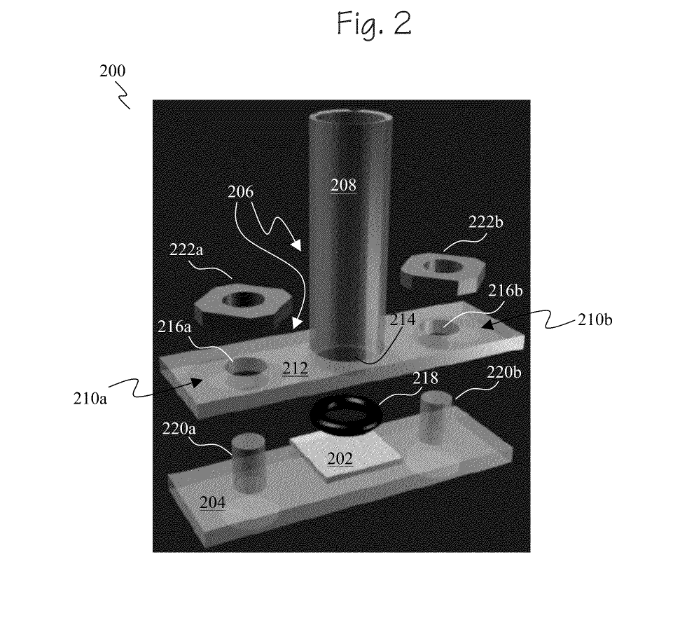

FIG. 2 shows an exploded view of an electrodeposition cell 200, according to various embodiments. The electrodeposition cell 200 may be designed to clamp a substrate with an anodized aluminum oxide (AAO) template, collectively represented by 202, to a supporting plate 204. In this way, only the top side of the AAO template 202 may be exposed to a metal ion containing solution (or electrolyte solution or electroplating solution) (not shown) that may be provided from the top. The top piece 206 making up the electrodeposition cell 200 may include a tube 208 and two wings 210a, 210b. The two wings 210a, 210b may be defined on a plate 212. The plate 212 may include an opening 214 which may be in fluid communication with the tube 208. The diameter of the tube 208 may be slightly smaller than the size of the AAO template 202. Each wing 210a, 210b may include a hole 216a, 216b. An O-ring 218 may be used to prevent or minimise the solution that may be provided through the tube 208 and to the AAO template 202 from leaking out. Under the O-ring 218, the supporting plate 204 with one fixed screw 220a, 220b on either side may be used to support the substrate with the AAO template 202. The locations of the fixed screws 220a, 220b may correlate or align with the holes 216a, 216b on the wings 210a, 210b. Two studs 222a, 222b may be used to balance the pressure to push the AAO template 202 against the supporting plate 204. A copper tape (not shown) may be provided on the supporting plate 204 and used to help introduce or deliver a current to the bottom side of the AAO template 202. A silver (Ag) foil (not shown) may be fixed to a silver wire (not shown) to serve as a counter electrode and reference electrode. The silver foil or plate may be arranged parallel to the AAO surface and kept about 5 mm away. For example, the Ag foil may be positioned above the AAO template 202, and inside the tube 208 inside the electrolyte solution to form an electro-chemical cell.

Various embodiments may provide processes to fabricate a nanocomposite film based on two types of anodized aluminum oxide (AAO) templates, for example a commercial AAO template and a self-grown AAO template.

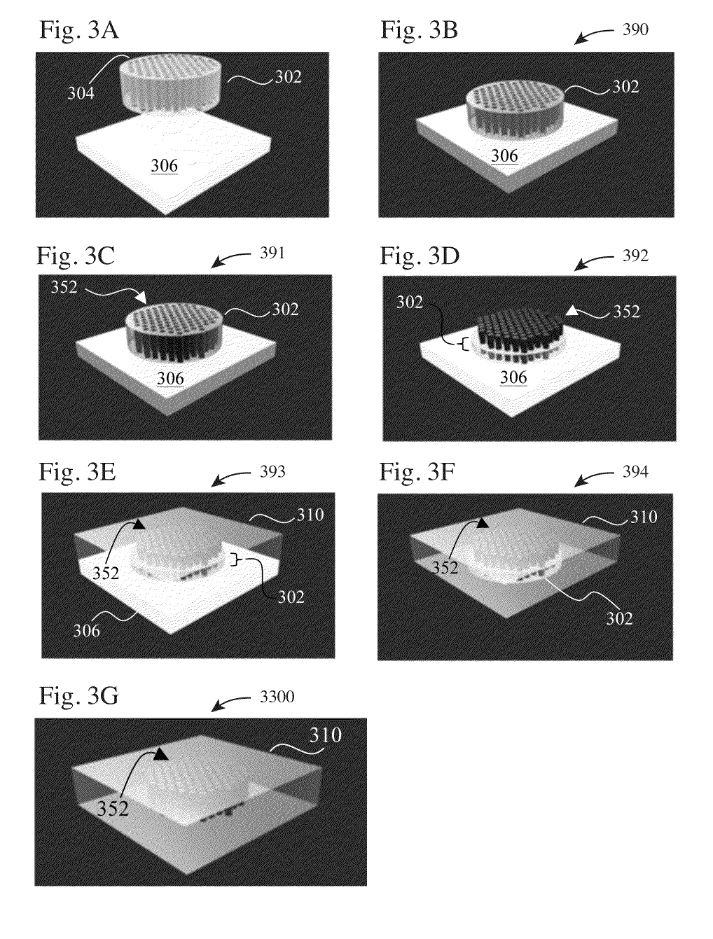

FIGS. 3A to 3G show, as perspective views, various processing stages of a method for synthesizing a metal-polymer nanocomposite film using a commercial anodized aluminum oxide (AAO) template, according to various embodiments.

Referring to FIG. 3A, an AAO template 302 with a plurality of holes or pores 304, and a substrate 306 may be provided. The holes 304 may be cylindrical holes. The holes 304 may be defined through the entire thickness of the AAO template 302. In various embodiments, the substrate 306 may be a metal foil, which may be at least substantially flat (e.g. a flat metal foil). The metal foil 306 may act as a conductive layer. The metal foil 306 may include but not limited to silver (Ag) or aluminium (Al).

The AAO template 302 may be hot-embossed onto the metal foil 306 to form a structure 390, as shown in FIG. 3B. Due to the high pressure and high temperature, the relatively soft metal foil 306 may deform and fuse into the pores or holes 304 of the AAO template 302 and immobilize the AAO 302 for a subsequent electrodeposition process.

The back of the metal foil 306 may be employed as a working electrode and a flat silver (Ag) foil (not shown) may be employed as a counter electrode and reference electrode for an electrodeposition process. For example, the Ag foil may be positioned above the AAO template 302 and inside an electrolyte solution (or electroplating solution) to form an electro-chemical cell for the electrodeposition process. Referring to FIG. 2 as an example, the electrolyte solution may be provided to the tube 208 and therefore the Ag foil may be arranged inside the tube 208. Electrodeposition may then be carried out, for example using an electroplating solution, to grow an array of nanowires (e.g. metal nanowires) 352 within the template 302. The electroplating solution may contain one or more materials or precursors for forming the nanowires 352. The deposition current may be about 1 mA and the process may last for about one hour. A structure 391 having nanowires 352 deposited within and through the holes 304 of the AAO template 302 may be obtained, as shown in FIG. 3C.

The AAO template 302 may then be etched partially (e.g. half-way etched) by a solution of about 20% H₃PO₄ (phosphoric acid) for about 2 hours to expose the top ends of the metal nanowires 352, leaving a portion (e.g. bottom or lower portion) of the AAO 302 to support the array of metal nanowires 352. A structure 392 may be obtained, as shown in FIG. 3D.

A miscible solvent may be used to replace the residual electroplating solution between the gaps of the nanowires 352 before a polymer solution, which may contain the same solvent, is spin-coated on top to seal the exposed ends of the array of nanowires 352. A structure 393 having a polymer film 310 over the exposed ends of the nanowires 352 and the remaining AAO template 302 may be obtained, as shown in FIG. 3E. The polymer film 310 may embed the exposed ends of the nanowires 352. The polymer film 310 may also embed the remaining AAO template 302.

The polymer film 310 may then be separated from the metal foil 306, for example using a sharp blade. As a result, the bottom ends of the array of nanowires 352 may be exposed. A structure 394 may be obtained, as shown in FIG. 3F.

An etching solution may then be used to remove the remaining metal foil 306 at the bottom side, and the remaining AAO template 302 may also be etched away from the structure 394 by the etching solution, before spin-coating the same polymer 310 on the bottom side of the resulting structure. A structure 300, being a free-standing nanocomposite film including nanowires 352 within a polymer 310 may be obtained, as shown in FIG. 3G.

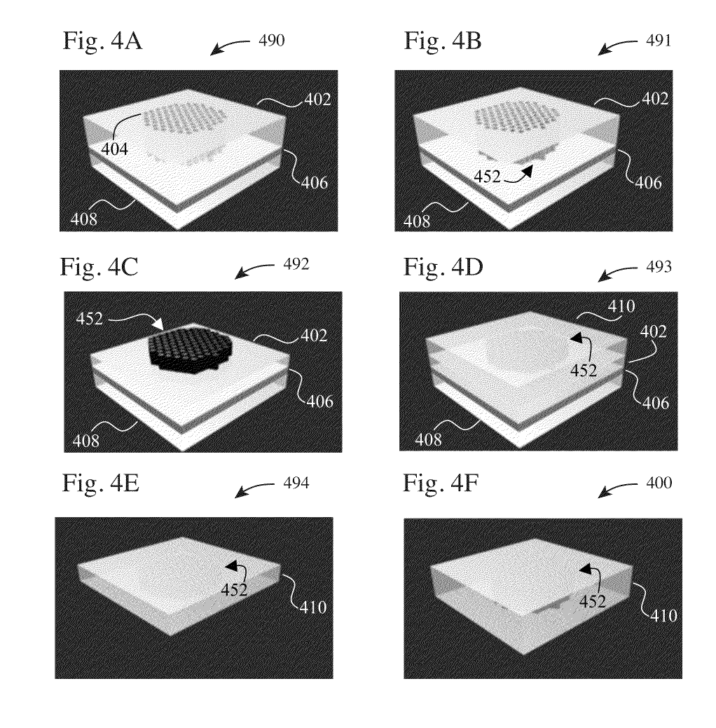

FIGS. 4A to 4F show, as perspective views, various processing stages of a method for synthesizing a metal-polymer nanocomposite film using a self-grown anodized aluminum oxide (AAO) template, according to various embodiments.

For a self-made AAO template, a conducting or conductive sacrificial layer may be formed on a solid substrate, for example by forming evaporated or sputtered copper (Cu) films on the solid substrate. An aluminium (Al) material may then be formed on the Cu films. An anodization process may then be performed, which may create a plurality of holes or pores (e.g. cylindrical holes) that may reach to the bottom of the Al material, and thus forming an anodized aluminium oxide (AAO) template. A structure 490 having an AAO template 402 with pores or holes 404 arranged over the Cu films acting as a conductive sacrificial layer 406 on a substrate 408 may be obtained, as shown in FIG. 4A.

The back of the conductive sacrificial layer 406 may be employed as a working electrode and a flat silver (Ag) foil (not shown) may be employed as a counter electrode and reference electrode for an electrodeposition process. For example, the Ag foil may be positioned above the AAO template 402 and inside an electrolyte solution (or electroplating solution) to form an electro-chemical cell for the electrodeposition process. Referring to FIG. 2 as an example, the electrolyte solution may be provided to the tube 208 and therefore the Ag foil may be arranged inside the tube 208. Electrodeposition may then be carried out, for example using an electroplating solution, to grow an array of nanowires (e.g. metal nanowires) 452 within the template 402. The electroplating solution may contain one or more materials or precursors for forming the nanowires 452. The deposition current may be between about 1 mA and the about 10 mA (e.g. about 1 mA) and the process may last for about 10 minutes to about one hour (e.g. about 60 minutes). A structure 491 having nanowires 452 deposited within and through the holes 404 of the AAO template 402 may be obtained, as shown in FIG. 4B.

The AAO template 402 may then be etched partially (e.g. half-way etched) by a solution of about 20% H₃PO₄ (phosphoric acid) for about 2 hours to expose the top ends of the metal nanowires 452, leaving a portion (e.g. bottom or lower portion) of the AAO 402 to support the array of metal nanowires 452. A structure 492 may be obtained, as shown in FIG. 4C.

A miscible solvent may be used to replace the residual electroplating solution between the gaps of the nanowires 452 before a polymer solution, which may contain the same solvent, is spin-coated on top to seal the exposed ends of the array of nanowires 452. A structure 493 having a polymer film 410 over the exposed ends of the nanowires 452 and the remaining AAO template 402 may be obtained, as shown in FIG. 4D. The polymer film 410 may embed the exposed ends of the nanowires 452. The polymer film 410 may also embed the remaining AAO template 402.

An etching solution may be used to remove the sacrificial layer (copper) 406 to release the polymer film 410 and expose the bottom ends of the array of nanowires 452. A structure 494 may be obtained, as shown in FIG. 4E.

Another etching solution may then be used to remove the remaining AAO template 402 from the structure 494, before spin-coating the polymer 410 on the bottom side of the resulting structure. A structure 400, being a free-standing nanocomposite film including nanowires 452 within a polymer 410 may be obtained, as shown in FIG. 4F.

Results relating to various embodiments will now be described by way of the following non-limiting examples, following the process steps as described herein using a commercially available AAO template.

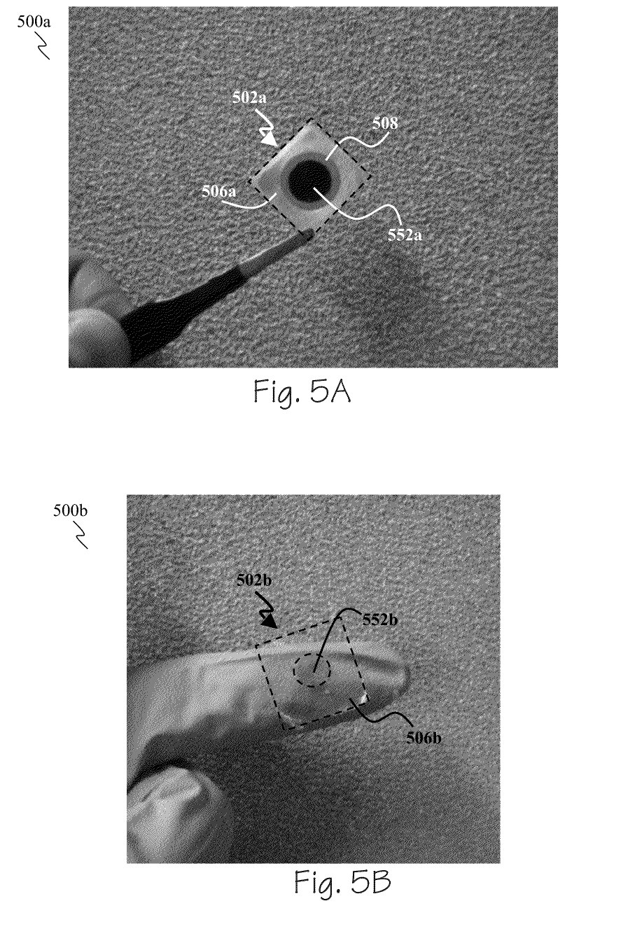

FIG. 5A shows an image 500a of a free standing film 502a (where the boundary is denoted by the dashed box) of silver (Ag) nanowires 552a inside or within PMMA (polymethyl methacrylate) 506a, while FIG. 5B shows an image 500b of a free standing film 502b (where the boundary is denoted by the dashed box) of silver (Ag) nanowires 552b (where the boundary is denoted by the dashed circle) inside or within PDMS (polydimethylsiloxane) 506b. Accordingly, the circular portions containing the nanowires 552a, 552b may form circular composite films, where the diameter of the circular composite films may be about 10 mm. The ring as denoted by 508 in FIG. 5A may include a polymer without metal nanowires, where the ring 508 may be thinner than the outer part of the film 502a which may be due to the wall thickness of the tube 208 (FIG. 2). Due to the nature of PMMA, the nanocomposite film 502a may be at least substantially rigid after it has been dried in air. For the PDMS nanocomposite film 502b, it remains at least substantially flexible after baking the film 502b.

FIG. 5C shows an image 500c of a nanocomposite film 502c with gold nanowires 552c in a polymer matrix 506c. The circular portion containing the nanowires 552c may form a circular composite film, where the diameter of the circular composite film may be about 2.5 cm.

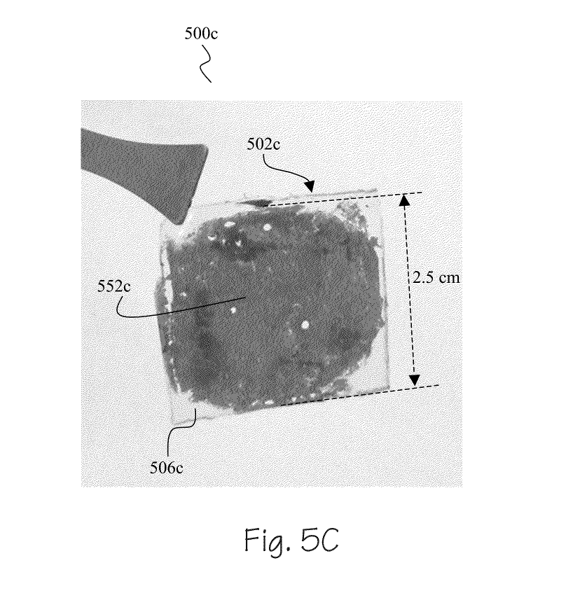

FIG. 6A shows a scanning electron microscope (SEM) image 600 of a top view of an anodized aluminum oxide (AAO) template, e.g. a commercial AAO template. As may be observed, the AAO template includes an array of pores, as represented by 602 for one such pore.

FIG. 6B shows a scanning electron microscope (SEM) image 650 of a top view of exposed ends of silver (Ag) nanowires, as represented by 652 for two nanowires, after part of the AAO template has been etched away. As may be observed, at least substantially straight Ag nanowires 652 may be standing up and formed at least substantially perpendicular to the surface, e.g. of a substrate. As at least some of the nanowires 652 may be too long to be self-supported, some of the tips of the nanowires 652 may be leaning against each other.

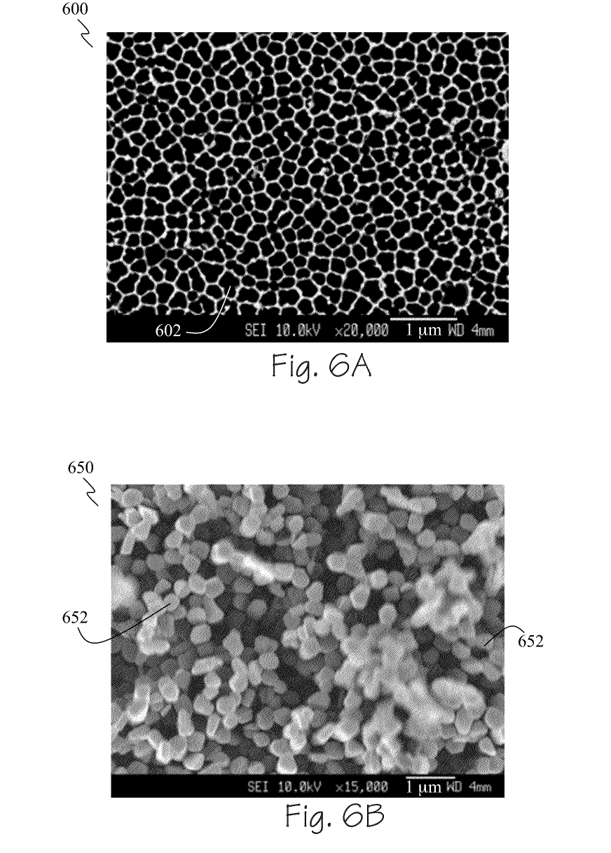

FIGS. 7A and 7B show respective scanning electron microscope (SEM) images 700, 750, of a cross sectional view of a silver (Ag)-polymer nanocomposite film, illustrating examples of a silver-PMMA nanocomposite film. As may be observed, silver (Ag) nanowires, as represented by 752 for a nanowire, may be formed standing at least substantially perpendicular to the surface of the film without any major collapse. The radius of each Ag nanowire 752 may be around 200 nm.

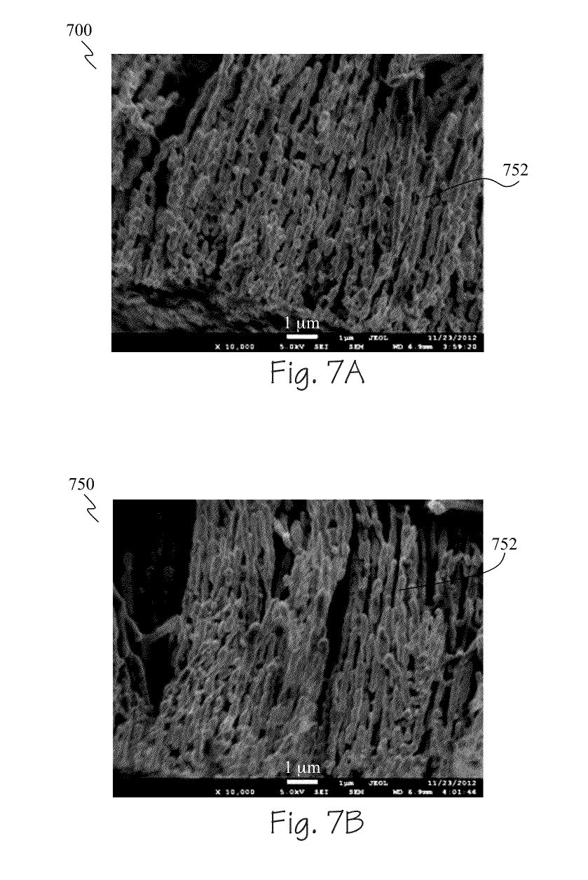

FIG. 8 shows an EDX (Energy-dispersive X-ray spectroscopy) spectrum 800 of a silver (Ag)-PMMA nanocomposite film, obtained based on a cross section of the silver-PMMA nanocomposite film, e.g. as illustrated in FIGS. 7A and 7B. The EDX spectrum shows strong Ag (silver) signals which may originate from the Ag nanowires. The Al (aluminium) peak may be from the residual AAO material and the P (phosphorus) signal may be from the etching procedure where H₃PO₄ (phosphoric acid) is used.

The fabricated metal-polymer nanocomposite film may be used as, but not limited to, meta-lens for optical imaging purposes. To give an example of the application, the numerical simulation as will be described below shows the negative refraction and high resolution imaging capability of the meta-lens.

In order to understand the applicability of the metal-polymer nanocomposite film as meta-lens, full-wave simulations were performed taking into consideration the cylindrical structure and the material properties. A Finite Difference Time Domain (FDTD) solver software/application was used for performing electromagnetic calculations.

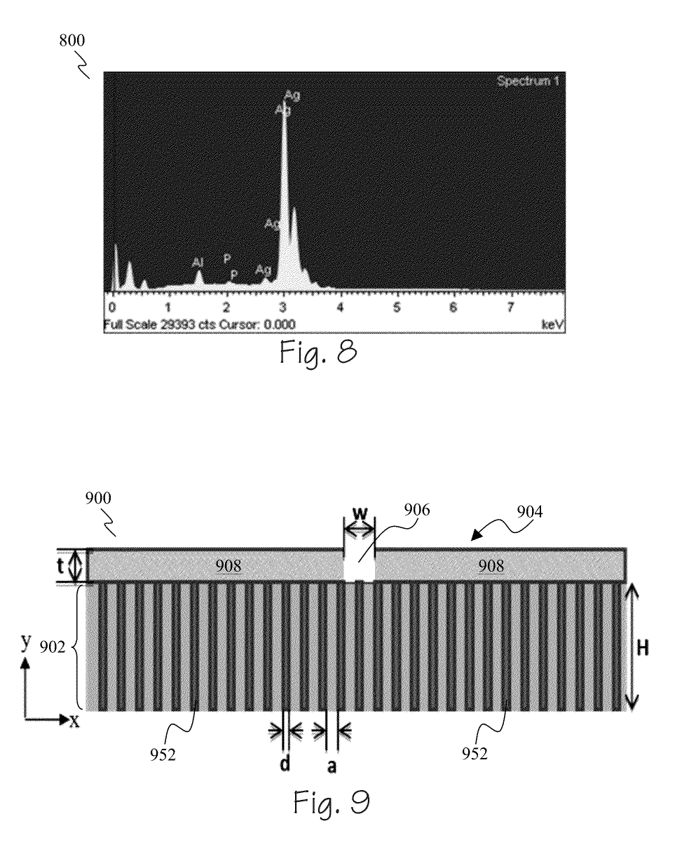

The model 900 used may be as shown in FIG. 9 illustrating a schematic cross sectional view of a nanowire meta-lens structure 902 with an object 904 on top. The model 900 may include an object 904 of a thickness, t, having a very small slit 906, with width, w<<λ (where λ is the incident or source wavelength), etched into a thin mask 908 which sits on top of the meta-lens 902. The meta-lens 902 includes an array of nanowires (or nanorods) 952, where the nanowires 952 may have a diameter, d, a height, H, and a centre to centre distance, a, between the nanowires 952. The various dimensions, w, a, d, H, and t, indicated in the model 900 may be assumed to be <λ, e.g. less than the incident or source wavelength. A transverse magnetic (TM) plane wave may be incident from the top of the mask 908 as a transverse electric (TE) plane wave may or would not couple to the slit 906.

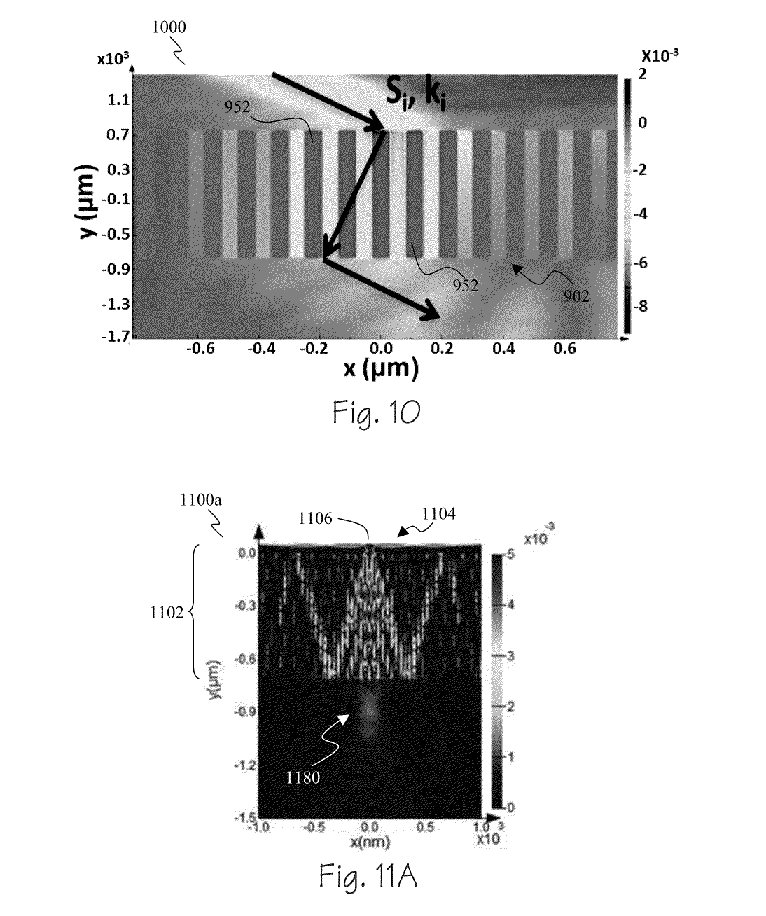

As a non-limiting example, a particular structure may be fabricated based on the model 900 and having the dimensions w=50 nm, H=500 nm, d=20 nm, t=50 nm, and a=40 nm. Periodic boundary conditions may be used along the x-axis. FIG. 10 shows a plot 1000 of Poynting vector (S) for a gaussian wave incident on a meta-lens 902, according to various embodiments, illustrating the negative refraction property for a gaussian wave incident at an angle to the meta-lens 902 at a wavelength of about 466 nm. Sᵢ and kᵢ indicate the incident Poynting vector and wave vectors. The arrows into, through and out of the meta-lens 902 mark the direction of energy flow in and through the lens 902.

Referring to FIG. 10, a Gaussian wave of a wavelength of about 466 nm and incident at an angle of about 60° to the lens 902 may refract negatively in the lens 902, as may be evident by the Poynting vector (energy flow) plot 1000. Therefore, the negative refraction capabilities of these meta-lenses may be observed from FIG. 10. Since the characteristic lengths of the meta-lens 902 are small compared to the wavelength of interest, it may be possible to remain in the domain where effective media description of these nanowires (or nanorods) 952 may be applicable.

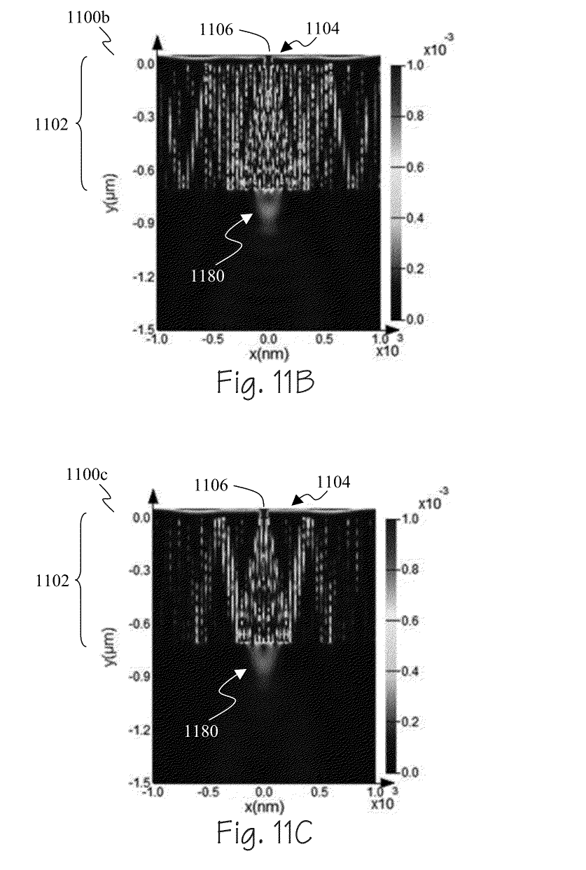

FIGS. 11A to 11C show plots 1100a, 1100b, 1100c, of the distribution of electric field intensities in a meta-lens 1102 at wavelengths, λ, of about 391.3 nm, about 435.5 nm and about 491 nm respectively. The height, H, of the nanowires of the meta-lens 1102 in all three cases is about 700 nm. The focus, shown in the form of a bright region and indicated by 1180, of the slit object 1106 may be clearly seen forming on the other side of the meta-lens 1102. After exiting the slit 1106 of the object 1104 which may be arranged over the meta-lens 1102, the beam may split into two and then are refocused by the lens 1102 on the other side. In other words, after being focused by the lens 1102, an image 1180 of the slit 1106 (which may be in 50 nm width), may be formed. As may be observed from FIGS. 11A to 11C, the image/focal spot 1180 seems to move closer to the lens 1102 with an increase in the source wavelength, λ.

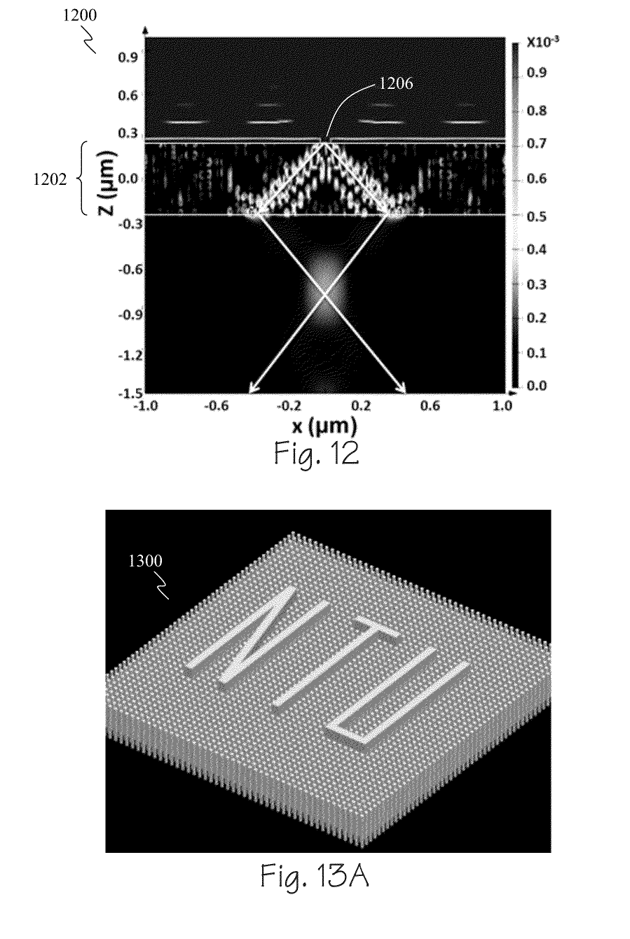

Simulation for a nanowire structure having a three-dimensional (3D) hexagonal arrangement of nanowires using periodic boundary conditions both in the x-axis and z-axis also show beam splitting, as illustrated in plot 1200 of FIG. 12 showing the electric field intensity distribution in a meta-lens 1202. As may be observed, the meta-lens 1202 may perform focusing of a sub-wavelength object, e.g. a slit 1206 with w=50 nm at a wavelength of about 466 nm. The arrows indicate the focusing action in the lens 1202. The structure boundaries of the meta-lens 1202 are indicated by the white lines.

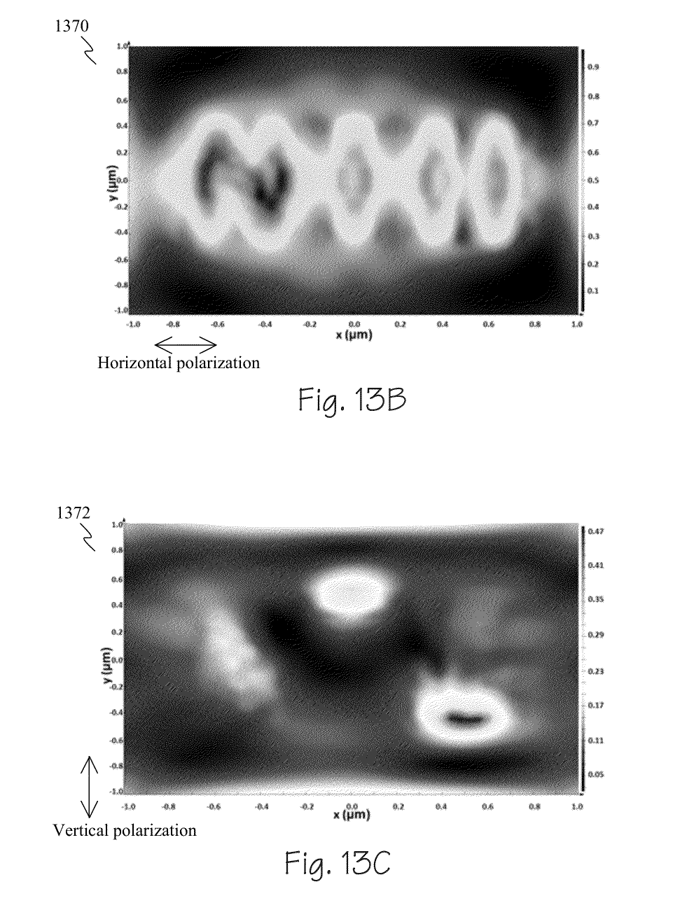

Imaging of 50 nm thin lines under two different polarizations at about 1200 nm wavelength may be obtained at about 40 nm position below a meta-lens as shown in FIGS. 13A to 13C. FIG. 13A shows an example of an object 1300 to be imaged, in 50 nm line width. FIGS. 13B and 13C show polarized images 1370, 1372, by a meta-lens of various embodiments at a wavelength of about 1200 nm, corresponding to horizontal polarization and vertical polarization respectively. A full image of the word “NTU” indicated in FIG. 13A may be formed by adding the two polarized images 1370, 1372.

From the above described simulation results, the capability of the ordered vertically-aligned metal nanowires or cylinders in a polymer matrix of various embodiments to be used for meta-lens applications may be observed. It should be appreciated that the meta-lens of various embodiments may be used for various optical imaging purposes.

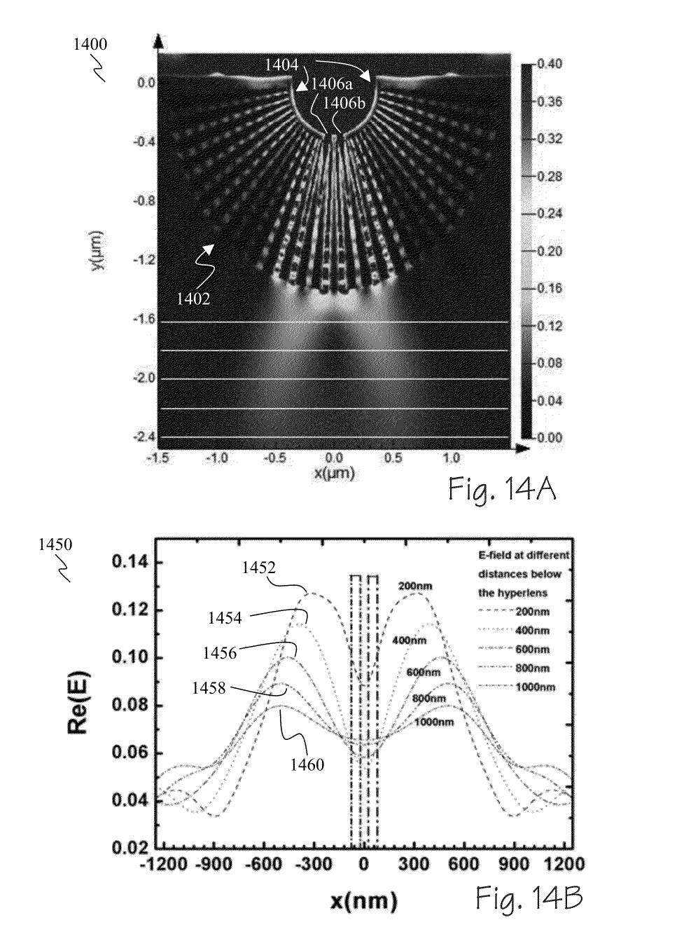

The free-standing flexible nanowire-polymer composite (film) of various embodiments may allow the formation of a curved film to be used as a hyperlens. FIG. 14A shows a plot 1400 of the optical simulation of far field imaging of a nanometer object 1404 by a curved hyperlens 1402, according to various embodiments, illustrating the electric field intensity distribution. The nanometer object 1404 may include two slits 1406a, 1406b, with a line width about 52.35 nm and a separation of about 52.35 nm. The two-slit object 1404 may have a thickness of about 100 nm. The curved hyperlens 1402 may have a thickness of about 1000 nm, with r1˜28 nm and r2˜90 nm, where r1 refers to the radius of the curve or curvature of the object 1404, while r2 refers to the radius of the curve or curvature of the curved hyperlens 1402. Clear separation of the two slits 1406a, 1406b may be observed at a distance up to about 1000 nm. This may be the highest achievable resolution in hyperlensing.

FIG. 14B shows a plot 1450 of the electric field intensity at different distances away from the hyperlens 1402. Plot 1450 shows the electric field intensity result 1452 for a distance of about 200 nm away from the hyperlens 1402, the electric field intensity result 1454 for a distance of about 400 nm away, the electric field intensity result 1456 for a distance of about 600 nm away, the electric field intensity result 1458 for a distance of about 800 nm away, and the electric field intensity result 1460 for a distance of about 1000 nm away. The five white lines indicated in FIG. 14A represent the increasing distances away from the hyperlens 1402. For example, the white line corresponding to y=−1.6 μm indicates a distance of about 200 nm away from the hyperlens 1402, while the white line corresponding to y=−2.4 μm indicates a distance of about 1000 nm away from the hyperlens 1402.

As described above, a composite film or a complete free-standing composite film may be fabricated by the method of various embodiments, which may be used as a superlens or hyperlens for high precision optical imaging. Various embodiments may use a thin conducting sacrificial layer to enable electro-chemical deposition of nanowires and release of the free-standing nanocomposite film, for example, for meta-lens applications. Using this method, long (e.g. >10 μm) and dense (e.g. about 10⁹-10¹¹ pores/cm²) array of metal nanowires embedded in a polymer film with smooth surface finishing below about 4 nm may be obtained (therefore, eliminating the energy loss of incident light at the surface due to minimized scattered light). Finite Difference Time Domain (FDTD) simulation of the nanostructures with ordered vertically-aligned silver nanowires in a polymer material as meta-lens and hyperlens has shown the capability of negative refraction and far field super-resolution imaging of a 50 nm slit at wavelengths of about 391.3 nm, 435.5 nm, 466 nm, 491 nm and 1200 nm.

Various embodiments may provide a scalable process to produce a metal-polymer nanocomposite film or a free-standing metal-polymer nanocomposite film with highly-ordered vertically-aligned metal nanowires, for example, for optical applications. The process may include one or more of the following: (1) usage of a hot-pressing technique in fixing anodized aluminum oxide (AAO) templates onto substrates; (2) usage of a conducting or conductive sacrificial layer to help the electrodeposition and release processes; (3) electro-chemical growth of nanowires (e.g. silver (Ag) nanowires) within pores of a template (e.g. an AAO template); (4) replacement of an AAO template by polymers by a solution process to obtain a flexible composite film; (5) a spin-coating process to make the nanocomposite surface very flat for optical applications; or (6) usage of a miscible solvent and half-way etching of the template to maintain the positions of nanowires within the polymer.

Various embodiments may also include an anodizing process to make or fabricate AAO templates on Al-covered substrates.

Various embodiments may also provide use of the produced nano-composite films with ordered vertically-aligned metal cylinders in polymer matrix as superlens and curved hyperlens for far field imaging of objects at a resolution of about 50 nm.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. A method for forming a composite film, the method comprising:
providing a nanowire forming template;
forming a plurality of nanowires through the nanowire forming template;
removing material from a partial portion of the nanowire forming template to expose a portion of the plurality of nanowires; and
forming a polymeric film between the plurality of nanowires to form a composite film.

2. The method as claimed in claim 1, wherein forming a polymeric film between the plurality of nanowires consists of forming the polymeric film at the exposed portion of the plurality of nanowires.

3. The method as claimed in claim 1, wherein removing material from a partial portion of the nanowire forming template comprises etching the nanowire forming template.

4. The method as claimed in claim 1, wherein removing material from a partial portion of the nanowire forming template comprises removing half of the nanowire forming template.

5. The method as claimed in claim 1, wherein forming a plurality of nanowires through the nanowire forming template comprises electrodepositing the plurality of nanowires.

6. The method as claimed in claim 1, further comprising providing a conductive layer, wherein providing a nanowire forming template comprises providing the nanowire forming template on the conductive layer.

7. The method as claimed in claim 6, wherein providing the nanowire forming template on the conductive layer comprises hot pressing or hot embossing the nanowire forming template on the conductive layer.

8. The method as claimed in claim 6, wherein providing a conductive layer comprises forming the conductive layer on a substrate.

9. The method as claimed in claim 9, wherein forming the conductive layer on a substrate comprises an evaporation process or a sputtering process.

10. The method as claimed in claim 6, wherein forming a plurality of nanowires through the nanowire forming template comprises forming the plurality of nanowires on the conductive layer.

11. The method as claimed in claim 10, wherein forming the plurality of nanowires on the conductive layer comprises electrodepositing the plurality of nanowires by means of the conductive layer to form the plurality of nanowires on the conductive layer.

12. The method as claimed in claim 10, further comprising removing the conductive layer.

13. The method as claimed in claim 12, wherein removing the conductive layer comprises etching the conductive layer.

14. The method as claimed in claim 1, further comprising providing a solvent between the plurality of nanowires prior to forming the polymeric film between the plurality of nanowires.

15. The method as claimed in claim 1, wherein forming a polymeric film between the plurality of nanowires comprises spin-coating a polymer solution corresponding to the polymeric film.

16. The method as claimed in claim 1, further comprising removing the remaining portion of the nanowire forming template.

17. The method as claimed in claim 16, further comprising forming the polymeric film between the plurality of nanowires that are exposed after the remaining portion of the nanowire forming template is removed.

18. The method as claimed in claim 1, wherein each nanowire comprises a metal.

19. The method as claimed in claim 1, wherein the nanowire forming template comprises an anodized aluminium oxide template or a di-block co-polymer self-assembled template.

20. The method as claimed in claim 1, wherein the nanowire forming template has a pore density of between about 10⁹ pores/cm² and about 10¹¹ pores/cm².
